(19) United States
(12) Patent Application Publication
(10) Pub. No.: US 2002/0130862 A1
(43) Pub. Date: Sep. 19, 2002

(54) System and method for modeling virtual object in virtual reality environment

(76) Inventors: Ji Hyung Lee, Taejon (KR); Do-Hyung Kim, Taejon (KR); In Ho Lee, Taejon (KR); Weon Geun Oh, Taejon (KR)

Correspondence Address: JACOBSON HOLMAN, PLLC, PROFESSIONAL LIMITED LIABILITY COMPANY, 400 Seventh Street, N.W., Washington, DC, 20004, US

(21) Appl. No.: 09/995,706

(22) Filed: Nov. 29, 2001

(30) Foreign Application Priority Data
Mar. 16, 2001 (KR) 2001-13803

(51) Int. Cl. G09G 5/00

(52) U.S. Cl. 345/420

(57) ABSTRACT

Disclosed are a system and method for transforming a shape of a virtual object in a virtual reality environment through the use of a motion and posture of virtual hand/fingers, and a contact condition with the virtual object, to thereby model the virtual object in the environment, without an additional acquirement of tools, which comprises a finger motion detector 110 and a hand motion detector 120 mounted on the actual hands/fingers of a user, for detecting a motion and posture of the actual hands/fingers; and a modeling system 130 for calculating a spatial region where virtual hand/fingers is contacted with the virtual object, which corresponds to the detected motion and posture of the actual hands/fingers, and transforming the virtual object by the calculated spatial region, thereby modeling the virtual object.

### FIELD OF THE INVENTION

The present invention relates to a 3D(three-dimensional) modeling application; and, more particularly, to a 3D modeling system and method for modeling a virtual object responsive to a motion of virtual hand/fingers corresponding to that of the actual hand/fingers of a user in a virtual reality environment.

### DESCRIPTION OF THE PRIOR ART

As a 3D modeling technique used in a computer graphic and its applications, there is a technique of modeling an object in a virtual reality environment using a 3D modeling software and a data input device such as a keyboard, a mouse, in a desktop environment. This technique suffers from drawbacks that acquirement of tools is extremely time consuming, modeling as such requires a significant amount of processing time, and it is difficult to model a real object.

As an alternative technique, there are a contactless 3D modeling technique using a 3D scanner and a contact 3D modeling technique using a 3D digitizer.

The 3D scanner-based contactless 3D modeling technique extracts images of the actual object from various angles through the use of an optical camera, and analyzes them to create a 3D model corresponding thereto. In this technique, since a significant amount of noises is contained in the created 3D model data and a volume of the data is significant, a processing for the data is a requisite for solution of the above problems.

Meanwhile, the 3D digitizer-based contact 3D modeling technique puts end-effects of the digitizer on features of an object, and computes 3D positions of the object to create a 3D model, wherein the end-effects are composed of several axes such as arms of a robot which can freely move in a 3D space. This technique, although to create a 3D model for the actual object like the 3D scanner mentioned above, suffers from drawbacks that a significant amount of time is needed to create the 3D model, and, in case a target model object is an organism, the modeling of the organism requires a longer time, thereby making it rather difficult to model the object during a change in a posture of the organism.

A technique is disclosed in the U.S. Pat. No. 5,870,220 issued on 1999 to Real-time Geometry Corporation, entitled “PORTABLE 3-D SCANNING SYSTEM AND METHOD FORM RAPID SHAPE DIGITIZING AND ADAPTIVE MESH GENERATION”, which projects a stripe of laser onto an object in a contactless fashion, collects the images of the laser stripe reflected from the object to perform a 3D scanning, forms a mesh based on points obtained so to create a 3D model. Unfortunately, this technique has defects that it requires an actual model for modeling and an additional post-processing.

### SUMMARY OF THE INVENTION

It is, therefore, a primary object of the present invention to provide a system and method, which is capable of transforming a shape of a virtual object in a virtual reality environment through the use of a motion and posture of virtual hand/fingers, and a contact condition with the virtual object, to thereby model the virtual object in the environment, without an additional acquirement of tools.

In accordance with one aspect of the present invention, there is provided a system for modeling a virtual object in a virtual reality environment into a desired shape, comprising: means mounted on the actual hands/fingers of a user, for detecting a motion and posture of the actual hands/fingers; and means for calculating a spatial region where virtual hand/fingers is contacted with the virtual object, which corresponds to the motion and posture of the actual hands/fingers detected at the detecting means, and transforming the virtual object by the calculated spatial region, thereby modeling the virtual object.

In accordance with another aspect of the present invention, there is provided a method for modeling a virtual object in a virtual reality environment into a desired shape, the method comprising the steps of: a) forming virtual hands/fingers having the same shape as the actual hands/fingers of a user in the virtual reality environment; b) detecting a motion and posture of the actual hands/fingers; c) calculating a spatial region where the virtual hand/fingers contacts with the virtual object corresponding to the detected motion and posture of the actual hands/fingers; and d) transforming the virtual object by the calculated spatial region.

### BRIEF DESCRIPTION OF THE DRAWINGS

The above and other objects and features of the present invention will become apparent from the following description of the preferred embodiments given in conjunction with the accompanying drawings, in which:

FIG. 1 is a schematic architecture of a 3D modeling system in accordance with a preferred embodiment of the present invention;

FIG. 2 is a flow chart, which will be used to describe the 3D modeling method in accordance with a preferred embodiment of the present invention;

FIG. 3 is a pictorial representation illustrating the posture of the virtual hand/fingers in the virtual reality environment;

FIG. 4A is a pictorial representation showing that an internal portion of a virtual palm and a finger slightly contacts with a virtual object;

FIG. 4B is a pictorial representation showing that a virtual finger excessively contacts with a virtual object, resulting in an excessively transformed virtual object;

FIG. 5 is a pictorial representation illustrating the approximating technique to be applied to the transformed virtual object obtained at FIG. 4B;

FIG. 6 is a pictorial representation illustrating the smoothing technique to be applied to the approximated virtual object obtained at FIG. 5;

FIG. 7 is a pictorial representation illustrating the drilling technique to be applied to the virtual object; and

FIG. 8 is a pictorial representation illustrating the cutting technique to be applied to the virtual object.

### DETAILED DESCRIPTION OF THE PREFERRED EMBODIMENTS

Noting that throughout the description the term “marking” means that prints a mark of virtual hand/fingers onto a virtual object, which is prepared with the virtual hand/fingers based on a motion of actual hand/fingers within a virtual environment; the term “approximating” that approximates an outward shape and contour of the virtual object; the term “smoothing” that smoothes or flats the shape of the virtual object obtained by the approximating; the term “drilling” that drills a hole on the virtual object due to an increase in a contact strength of the virtual hand/fingers on the virtual object; the term “cutting” that cuts the virtual object by penetrating the virtual hand/fingers through the virtual object; and the term “slicing” that slices one side of the virtual object.

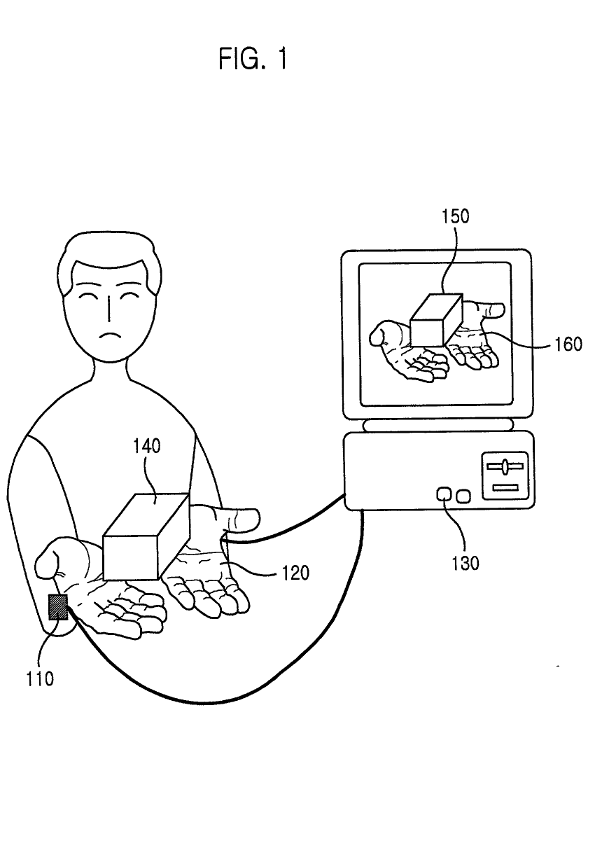

FIG. 1 is a schematic architecture of a 3D modeling system in accordance with a preferred embodiment of the present invention.

As shown in FIG. 1, the architecture of the present invention comprises a finger motion detector 110, a hand motion detector 120 and a modeling system 130. The finger motion detector 110, which is mounted on fingers of a user, detects a motion of the actual fingers of the user. The hand motion detector 120, which is mounted on the hand of a user, detects a motion of the actual hand of the user. The modeling system 130 equalizes the detected motion of the actual hand/fingers with a motion of virtual hand/fingers 160 in a virtual reality environment, and models the virtual object 150 in the virtual reality environment, according to a contact condition between the motion and posture of the virtual hand/fingers 160 and the virtual object 150 corresponding thereto.

A detailed description will be made as to the operation of the 3D modeling system with the above architecture.

Firstly, if the virtual object 150 is prepared within the modeling system 130, the user wears the finger motion detector 110 and the hand motion detector 120 on its own hand and fingers. Thereafter, the modeling system 130 performs a calibration process, which determines whether or not the motion of the hand/fingers of the user is equal to that of the virtual hand/fingers 160 in the virtual reality environment. Next, the modeling system 130 determines whether it contacts with the virtual object 150 by using a position and azimuth of the virtual hand/fingers 160, and calculates a force applied to the virtual object through the motion of the fingers. In addition, the bend degree of the virtual fingers is reflective of that of the actual fingers. Calculating a shape of the virtual fingers and the palm of the hand produces a posture of the hands. Thus, it is possible to estimate the shape of the hands contacted with the virtual object through the use of the posture of the virtual hands, and transform the virtual object based on the estimated result, thereby modeling the virtual object into a desired shape.

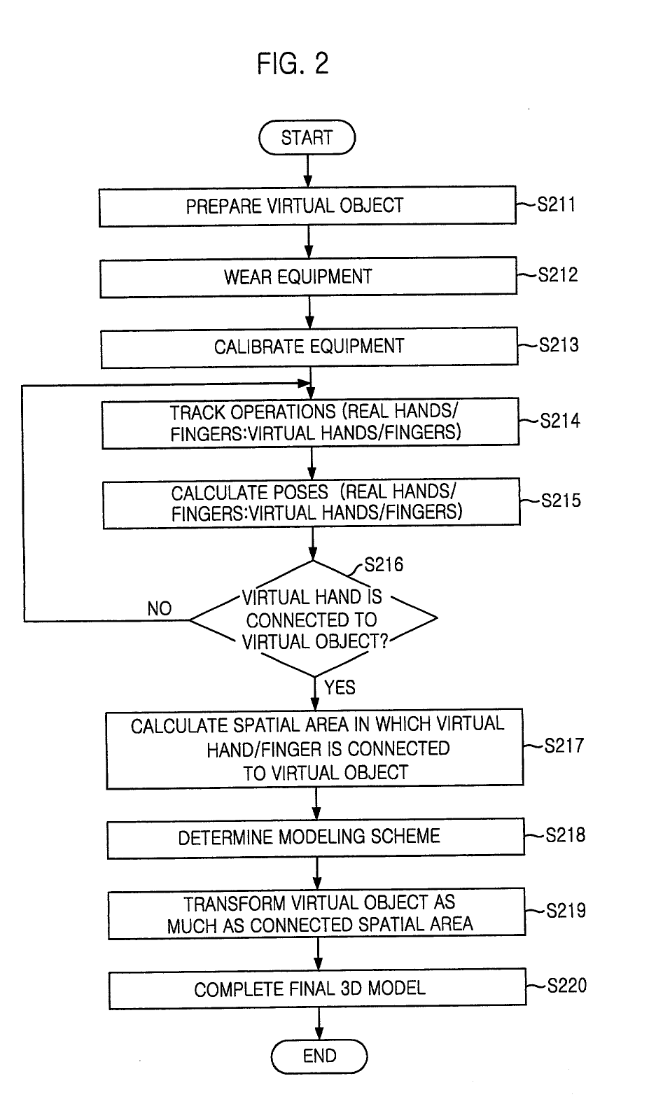

A detailed description will be made as to the operation of the 3D modeling system with the aforementioned features. FIG. 2 is a flow chart, which will be used to describe the 3D modeling method in accordance with a preferred embodiment of the present invention.

At step S211, if a virtual object is prepared through the modeling system in a virtual reality environment, at step S212 the user wears the finger motion detector 110 and the hand motion detector 120 on its own hand and fingers. Thereafter, at step S214 the control process performs a calibration process, which equalizes the motion of the hand/fingers of the user to that of the virtual hand/fingers in the virtual reality environment, estimates a motion of the actual hand/fingers and a bend degree of the fingers.

In an ensuing step S215, the control process performs a calibration of allowing the position of the actual hand and the posture of the actual fingers to be equal to that of the virtual hand/fingers. Next, at step S216 the control process determines whether the virtual hand/fingers contacts with the virtual object. At step S216, if the virtual hand/fingers contacts with the virtual object, at step S217 the control process calculates a spatial region where the virtual hand/fingers contacts with the virtual object and goes step S218; and otherwise, again estimates the motion of the actual hand and a bend degree of the actual fingers. Thus, if the spatial region where the virtual hand/fingers contacts with the virtual object is calculated (if the actual hand/fingers reach the virtual object, the process computes a volume with which the virtual palm hand and the virtual fingers contact the virtual object, and transforms the virtual object by the computed volume), at step S218 the process determines a modeling technique for the virtual hand/fingers and goes to step S219 wherein the virtual object is transformed by the contacted spatial region. Thus, at step S220 a final 3D model is created in the virtual reality environment.

In this case, if the user performs the modeling while directly contacting the actual object, the virtual object in the environment may be modeled as a virtual object having the same shape as the transformed actual object.

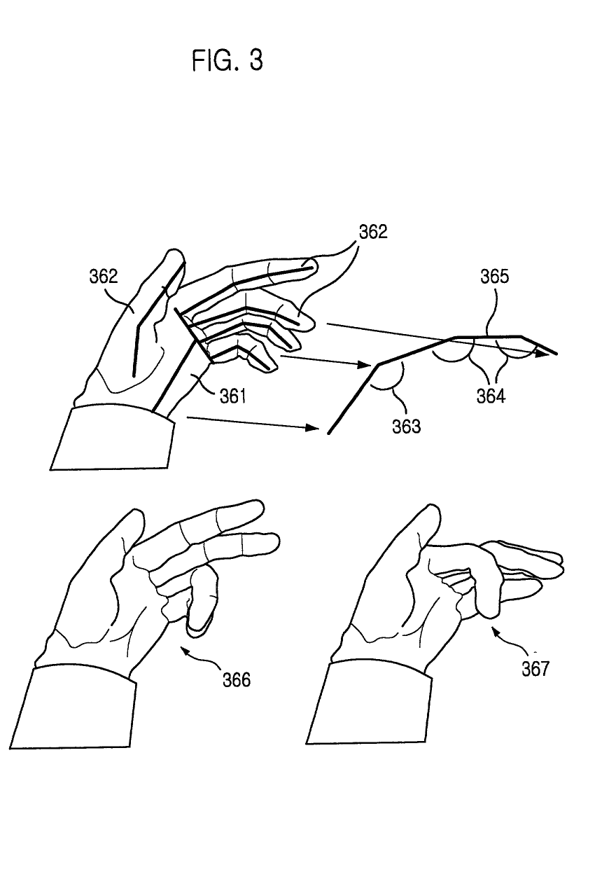

Through the procedures above, there are several techniques of forming a 3D model within the virtual reality environment, which are shown in FIGS. 3 to 8.

FIG. 3 is a pictorial representation illustrating the posture of the virtual hand/fingers in the virtual reality environment. As shown in FIG. 3, the shape of the virtual object is varied according to the posture of the virtual hand and the bend degree of the virtual fingers.

Thus, it is possible to cipher a contact strength, region and shape of the virtual hand/fingers contacted to the virtual object using the posture and motion of the virtual hand, thereby transforming the virtual object based on the ciphered results. In this case, the virtual fingers may be formed with one or more of fingers, resulting in various postures of hand.

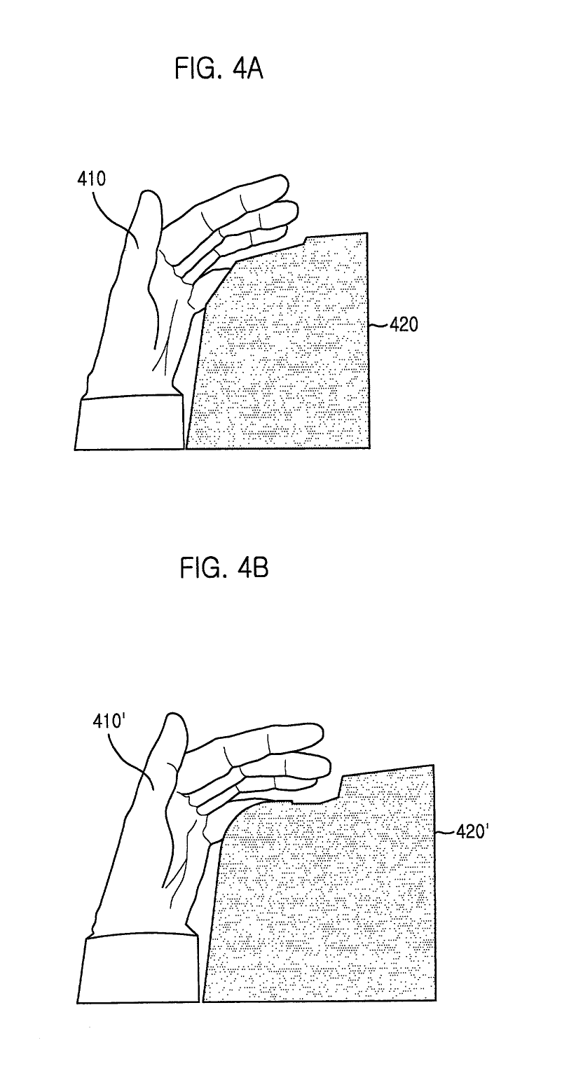

As mentioned above, various modeling techniques may be implemented according to the contact strength, region and shape of the virtual hand/fingers contacted to the virtual object. FIGS. 4A and 4B are pictorial representations illustrating the marking technique among the various modeling techniques.

FIG. 4A is a pictorial representation showing that an internal portion of a virtual palm and a finger 410 slightly contacts with a virtual object 420, and FIG. 4b is a pictorial representation showing that a virtual finger 410′ excessively contacts with a virtual object 420, resulting in an excessively transformed virtual object 420′. As shown in FIGS. 4A and 4B, the virtual objects 420 and 420′ are transformed into the same shape as the volume of the virtual palm and the fingers 410 and 410′.

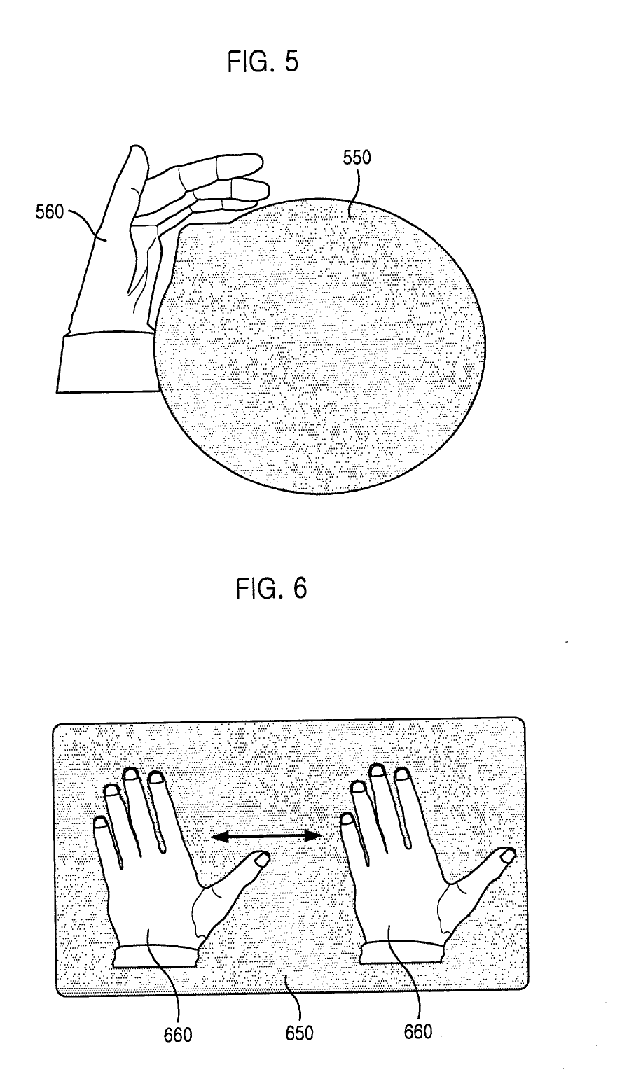

FIG. 5 is a pictorial representation illustrating the approximating technique to be applied to the transformed virtual object obtained at FIG. 4b, which approximates an outward shape and contour of a virtual object 550 according to a posture, motion and contact of a virtual hand/fingers 560.

FIG. 6 is a pictorial representation illustrating the smoothing technique to be applied to the approximated virtual object obtained at FIG. 5, which smoothes or flats the shape of the approximated virtual object. As shown in FIG. 6, the outward shape of a virtual object 650 is smoothly transformed while moving a virtual hand 660.

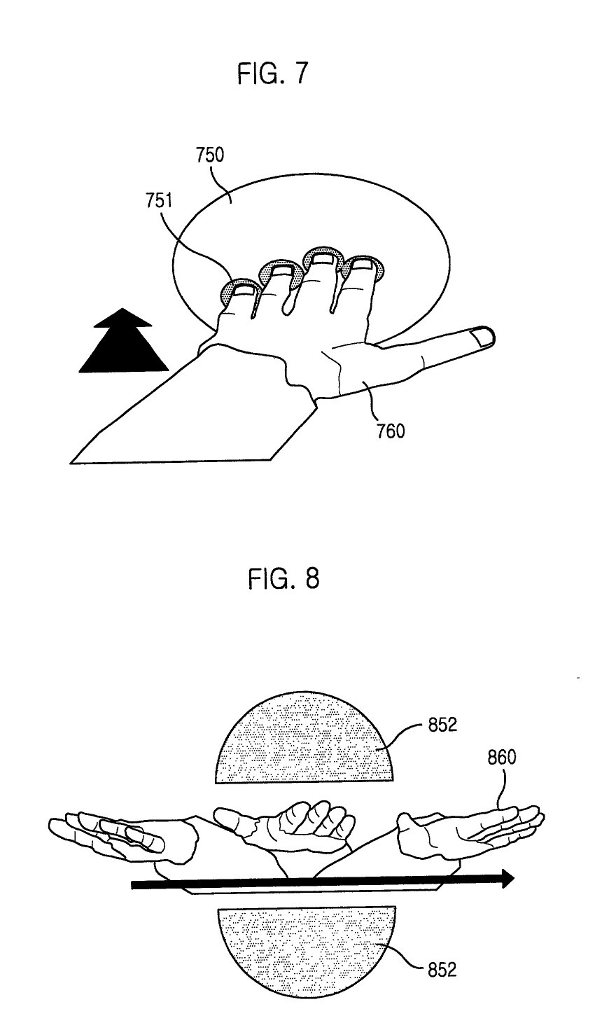

FIG. 7 is a pictorial representation illustrating the drilling technique to be applied to the virtual object. As shown in FIG. 7, a strong contact of a virtual finger/palm 760 with a virtual object 750 in an arrow direction creates a hole 751 into the virtual object 750.

FIG. 8 is a pictorial representation illustrating the cutting technique to be applied to the virtual object. As shown in FIG. 8, the virtual object 750 is divided into two virtual objects 852 by penetrating virtual hands/fingers 860 through the virtual object in an arrow direction. On the one side, the slicing technique gradually slices the outward shape of the virtual object in the virtual hands/fingers to smooth the virtual object.

As demonstrated above, the present invention transforms a shape of a virtual object in a virtual reality environment through the use of virtual hands/fingers having the same motion and posture as the actual hands/fingers of a user, to thereby model a 3D virtual object similar to the actual one in the environment at a high speed like the 3D scanning-based modeling, without requiring an additional acquirement of tools.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

What is claimed is:

1. A system for modeling a virtual object in a virtual reality environment into a desired shape, comprising:
detecting means mounted on the actual hands/fingers of a user, for detecting a motion and posture of the actual hands/fingers; and
modeling means for calculating a spatial region where virtual hand/fingers is contacted with the virtual object, which corresponds to the motion and posture of the actual hands/fingers detected at the detecting means, and transforming the virtual object by the calculated spatial region, thereby modeling the virtual object.

2. The system as recited in claim 1, wherein the detecting means includes:
a hand motion detector mounted on the actual hand of the user, for detecting the motion and the posture of the actual hand; and
a finger motion detector mounted on the actual fingers of the user, for detecting the motion and the posture of the actual fingers.

3. The system as recited in claim 1, wherein the modeling means includes:
forming means for forming the virtual hands/fingers having the same shape as the actual hands/fingers in the virtual reality environment;
equalizing means for equalizing the motion and posture of the actual hands/fingers detected at the detecting means to that of the virtual hand/fingers;
computing means for computing the spatial region where the virtual hand/fingers contacts with the virtual object corresponding to the motion and posture of the actual hands/fingers; and
transforming means for transforming the virtual object by the computed spatial region at the computing means.

4. The system as recited in claim 3, wherein the computing means further computes a spatial region for a volume where the virtual hands/fingers contact with the virtual object, during the computation of the contacted spatial region.

5. The system as recited in claim 3, wherein the transforming means transforms the virtual object into a shape similar to the volume of the virtual hands/fingers contact e d with the virtual object.

6. A method for modeling a virtual object in a virtual reality environment into a desired shape, the method comprising the steps of:
a) forming virtual hands/fingers having the same shape as the actual hands/fingers of a user in the virtual reality environment;
b) detecting a motion and posture of the actual hands/fingers;
c) calculating a spatial region where the virtual hand/fingers contacts with the virtual object corresponding to the detected motion and posture of the actual hands/fingers; and
d) transforming the virtual object by the calculated spatial region.

7. The method as recited in claim 6, wherein the step a) includes the steps of:
a1) preparing the virtual object in the virtual reality environment; and
a2) extracting a posture of the actual hand of the user, and forming the virtual hands/fingers corresponding to the extracted posture in the virtual reality environment.

8. The method as recited in claim 6, wherein the step c) includes the step of equalizing the motion and posture of the virtual hand/fingers with that of the actual hands/fingers extracted at the step a2).

9. The method as recited in claim 6, wherein the step c) includes the step of computing a spatial region for a volume of the virtual hands/fingers contacted with the virtual object, during the computation of the contacted spatial region.

10. The method as recited in claim 6, wherein the step d) includes the step of transforming the virtual object into a shape similar to the volume of the virtual hands/fingers contacted with the virtual object.
